(19) United States
(12) Patent Application Publication
(10) Pub. No.: US 2006/0176684 A1
(43) Pub. Date: Aug. 10, 2006

(54) An Improved Outdoor Light Device

(76) Inventor: Simon Nicholas Richmond, Princeton, NJ (US)

Correspondence Address: SYNNESTVEDT LECHNER & WOODBRIDGE LLP, P O BOX 592, PRINCETON, NJ, 08542-0592, US

(21) Appl. No.: 11/275,992

(22) Filed: Feb. 8, 2006

Related U.S. Application Data
(60) Provisional application No. 60/651,774, filed on Feb. 9, 2005.
(60) Provisional application No. 60/654,353, filed on Feb. 18, 2005.

(51) Int. Cl. F21S 8/00

(52) U.S. Cl. 362/153

(57) ABSTRACT

An outdoor light device having a light transmitting housing portion and weather-proofingly containing a solar energy converting device. The device may also weather-proofingly contain a light-emitting element and a rechargeable electrical power source. The solar energy converting device may be located adjacent to a closed upper end of a light transmitting portion of the housing. There may also be a lid portion, having an aperture, configured to fit snugly over the closed upper end, such that light is able to pass through the closed upper end of the housing portion and fall on the solar panel. The outdoor light device may be made modular by including a removable, operative components module that is receivable in and separable from the housing portion of the light device. The operative components module may contain the light emitting element, solar power converting device and be capable of receiving the rechargeable electrical power source.

### CROSS REFERENCE TO RELATED APPLICATIONS

This application is related to, and claims priority from, U.S. Provisional Patent application no. 60/651,774 entitled “A waterproof outdoor light device” filed on Feb. 9, 2005 and to U.S. Provisional Patent application no. 60/654,353 entitled “A modular outdoor light device” filed on Feb. 18, 2005 the contents of both of which are hereby incorporated by reference.

The application is also related to U.S. patent application Ser. No. 11/303,247 “An Illuminated Wind Indicator” filed on Dec. 16, 2005 by Simon Richmond, the contents of which are hereby incorporated by reference.

### FIELD OF THE INVENTION

The present invention relates to outdoor light devices, and more particularly to waterproof and modular outdoor light devices.

### BACKGROUND OF THE INVENTION

It is known to provide an outdoor light device that includes a light source in the form of one or more LEDs, rechargeable batteries arranged to supply power to the LEDs, and solar panels arranged to convert light to electrical power for recharging the rechargeable batteries.

In one existing such outdoor light device, the solar cells are mounted on a substrate, the solar cells and the substrate are coated with an epoxy resin and cured in an oven, and the substrate is glued to a housing containing the LEDs.

However, the gluing step is generally a manual process and, as such, is prone to process variations that can result in varying quality of sealing. In addition, heat treatment of the epoxy resin and gluing the substrate take a substantial amount of processing time.

In an alternative existing outdoor light device, the solar cells are mounted in a depression formed in an outwardly facing surface of the housing containing the LEDs, and the solar cells are coated with an epoxy resin. The housing is then placed in an oven and heated to cure the resin.

However, heat treatment of the resin takes a substantial amount of processing time and the oven space required to encompass the housing is significant. Moreover, this manufacturing process is only suitable for solar lights with a plastic housing and, under certain processing conditions, the epoxy can separate from the housing allowing water ingress into the housing.

In a further existing outdoor light device, a transparent plastic cover and a transparent plastic housing are separately produced by injection molding, solar panels are disposed between the cover and the housing, and the cover and housing are secured together by ultrasonic welding. Such a process removes the need for epoxy gluing or ultrasonic welding but can sometimes produce a “short” molding that does not result in a fully waterproof seal and is difficult to detect by inspection. The process also requires a high level of process control to ensure that the ultrasonic welding step results in a fully waterproof seal. Visual inspection of the results of the process cannot guarantee an adequate verification of waterproofing.

In a further existing outdoor light device, a transparent plastic cover is produced by an injection molding process and placed inside an injection-molding machine so as to produce a top housing by an over-molding process. This process requires either an operator or an expensive robot to place the transparent plastic panel cover into the molding machine for over-molding.

A further problem associated with outdoor light devices, in situations where outwardly facing portions of the light device are susceptible to corrosion, is that it is difficult to restore the corroded parts of the light device without completely dismantling the light device. Moreover, in some situations it is only possible to carry out restorative work on outwardly facing portions of the light device in situ, which is often difficult.

### SUMMARY OF THE INVENTION

The present invention relates to an improved outdoor light device that overcomes many of the aforementioned shortcomings of existing light devices.

In a preferred embodiment of the present invention, the light device includes a housing portion that is able to transmit light, and contains at least one light-emitting element that is weather-proofingly contained within the light device. The light device of the preferred embodiment further includes at least one solar energy converting device arranged to convert solar energy to electrical power that is weather-proofingly contained within the housing portion. There is also at least one rechargeable electrical power source for supplying electrical power to the at least one light emitting element and for receiving electrical power from the at least one solar energy converting device that is weather-proofingly contained within the light device.

In a further preferred embodiment of the invention, directed more specifically to making the outdoor light device waterproof, the housing portion of the device has a light transmissive portion with a lower end and a closed upper end. In this embodiment, the at least one solar energy converting device is disposed to be adjacent to the closed upper end of the housing portion. This embodiment may also have a lid portion that is configured so as to fit snugly over the closed upper end of the light transmissive housing. The lid has a first aperture located such that when the lid portion is placed on the closed upper end of the transmissive housing, light is able to pass through the closed upper end of the housing portion and fall on the solar panel.

This embodiment provides an outdoor light device that is inexpensive to manufacture, easy to install and provides superior weatherproofing, particularly to moisture. In particular, since the solar energy converting device is disposed in the housing portion and the housing portion is completely closed, the risk of ingress of water through the upper end of the housing is avoided, this being achieved using a much simpler manufacturing process than manufacturing processes known hitherto.

In yet a further preferred embodiment of the invention, directed more specifically to a modular outdoor light device, the housing portion of the outdoor light device has a body portion having at least one first body portion aperture. The outdoor light device also includes a removable, operative components module that is receivable in and separable from the housing portion of the light device. This operative components module includes the at least one light emitting element and the at least one solar power converting device. The operative components module is also capable of receiving the at least one rechargeable electrical power source.

This embodiment provides an outdoor light device that is easy to maintain and repair. In particular, the design allows the housing portion to be made of materials such as, but not limited to, wood. When the exposed wood requires maintenance such as, but not limited to, revarnishing, the operative components module may be easily removed, the housing treated appropriately without danger of damaging the operative components of the lighting device, and the lighting device easily reassembled.

These and other features of the invention will be more fully understood by references to the following drawings.

### BRIEF DESCRIPTION OF THE DRAWINGS

The present invention will now be described, by way of example only, with reference to the accompanying drawings, in which:

FIG. 1 is a diagrammatic exploded view of outwardly facing components of a modular light device in accordance with an embodiment of the present invention;

FIG. 2 is a diagrammatic perspective view of a body portion of the components shown in FIG. 1;

FIG. 3 is a diagrammatic perspective view of a light transmissive module of a modular light device in accordance with an embodiment of the present invention;

FIG. 4 is a diagrammatic perspective view of a lid portion of the components shown in FIG. 1;

FIG. 5 is a diagrammatic cross-sectional view of an upper portion of a modular light device in accordance with an embodiment of the present invention;

FIG. 6 is a diagrammatic upper perspective view of an operative components module of the modular light device shown in FIG. 5;

FIG. 7 is a diagrammatic lower perspective view of the operative components module shown in FIG. 6;

FIG. 8 is a diagrammatic cross-sectional view of a lower portion of the modular light device shown in FIG. 5; and,

FIG. 9 is a cross-sectional view of the lower portion of the modular light device shown in FIG. 8 with the modular light device shown supported on a support clip.

FIG. 10 is a diagrammatic perspective view of a waterproof outdoor light device in accordance with an embodiment of the present invention;

FIG. 11 is a diagrammatic exploded view of components of a waterproof outdoor light device in accordance with an embodiment of the present invention;

FIG. 12 is a diagrammatic perspective view in cross-section of an upper portion of the outdoor light device shown in FIGS. 1 and 2; and

FIG. 13 is a block diagram showing operative components of the light device shown in FIGS. 10 to 13.

### DETAILED DESCRIPTION

The present invention applies to improved outdoor lights, and particularly to modular and waterproofed outdoor lights.

In a preferred embodiment of the invention, the outdoor light device consists of a housing portion that has the ability to transmit light and which contains the light emitting element, the solar energy converting device and the rechargeable battery in a weather proof manner. The light emitting element is typically, but not limited to, a light emitting diode (LED) and the solar energy converting device is typically, but not limited to, silicon solar cells that may be mounted on a printed circuit board. The weather proofing results from the design of the housing.

In a further preferred embodiment, for instance, the housing has a light transmitting portion with an extended lower end and a closed upper portion so as to resemble an inverted transparent tumbler. The solar energy converting device is positioned inside the housing close to the upper light transmitting area. A protective lid having a cut out aperture is fitted over the top to provide structural protection while letting light through to the solar energy converting device. This provides an inexpensive outdoor light device that is relatively well weather proofed.

In one arrangement of this embodiment, the lower end of the housing portion is open.

The housing portion may be arranged to receive the at least one rechargeable electrical power source.

In one arrangement of this embodiment, the lid portion is formed of opaque material which may be plastics, metal, wood or cold cured resin material.

In one arrangement of this embodiment, the housing portion is formed of transparent material. Alternatively, the housing portion may be formed of translucent material. The housing portion may be formed of plastics material.

In one further embodiment, the housing portion is connectable at the lower end to a body portion which may be formed of opaque material. The lower end of the housing portion may include a first screw threaded portion and an upper end of the body portion may be provided with a second complimentary screw threaded portion, the first and second screw threaded portions facilitating screw threaded connection of the housing portion to the body portion. In one arrangement, the housing portion includes a circumferential stepped portion which separates the housing portion into first and second cylindrical portions, the first cylinder portion being disposed at the upper end of the housing portion and being of reduced diameter relative to the second cylindrical portion.

The upper end of the housing portion may include a raised portion configured so as to fit snugly in the first aperture.

The outdoor light device may further comprise a support member arranged to hold the at least one rechargeable power source. The support member may be resilient and may also hold the at least one light emitting element.

In one further embodiment, the outdoor light device further comprises means for causing the at least one light emitting element to emit flickering light.

The or each light emitting element may be an LED. Each LED may be arranged to emit light of any color.

In one further embodiment, the at least one light emitting element, the at least one solar energy converting device and the rechargeable electrical power source are all disposed in the housing portion adjacent the upper end.

In this way, the likelihood of water passing between the housing portion and the body portion and onto the solar energy converting device(s) and other corrosion sensitive components of the light device is minimized.

In a further preferred embodiment of the invention, the outdoor light is made more modular by having a housing portion and a separate operative components module that removably fits into the housing portion and contains the light emitting element, the solar power converting device and the rechargeable electrical power source. In this embodiment, the housing portion has at least one aperture for transmitting light.

In one embodiment, the light device comprises a light transmissive module receivable in the body portion and configured such that when the light transmissive module is received in the body portion, portions of the light transmissive module are disposed over the at least one first body portion aperture.

In one arrangement of this embodiment, the body portion comprises an open upper end portion, and the modular light device further comprises a lid portion having a lid portion aperture, the lid portion being engageable with the upper end portion of the body portion and the lid portion being configured such that when the lid portion is engaged with the body portion, the at least one solar power converting device is disposed adjacent the lid portion aperture. The operative components module may be receivable in the body portion and/or the lid portion.

In one arrangement of this embodiment, the light transmissive module is at least partially formed of transparent material. Alternatively, the light transmissive module is at least partially formed of translucent material.

The light transmissive module may be formed of a plurality of connected light transmissive panels. The light transmissive panels may be connected together using a frame which may be formed of metal material. The light transmissive panels may be removably connected to the frame using clips. The light transmissive panels may be formed of glass or plastics material.

In one arrangement of this embodiment, the operative components module includes a battery compartment for removably receiving at least one rechargeable electrical power source, and a transparent cover member engageable with the battery compartment, the battery compartment and the transparent cover member being configured so that the at least one solar power converting device is receivable between the battery compartment and the transparent cover member. Preferably, the shape of the transparent cover member is complimentary to the shape of the lid portion aperture so that the transparent cover member and thereby the operative components module is able to sit snugly in the lid portion aperture.

In one arrangement of this embodiment, the body portion is provided with at least one bevelled portion, each beveled portion defining a first body portion aperture.

In one further embodiment, the body portion further comprises a second body portion aperture formed in a lower end portion of the body portion, the second body portion aperture serving to receive a support member such as a spike during use.

The modular light device may further comprise a support clip fixable to a structure, for example using screws, the support clip being engageable with the second body portion aperture so as to facilitate removable connection of the body portion to the support clip. For this purpose, the support clip may include a plurality of prongs.

The body portion and/or the lip portion may be formed of wood.

In one embodiment, the light device further comprises means for causing the at least one light emitting element to emit flickering light.

The or each light emitting element may be an LED. Each LED may be arranged to emit light of any color.

Various embodiments of the invention will now be described in more detail by reference to the attached drawings in which, as far as possible, like numbers represent like elements.

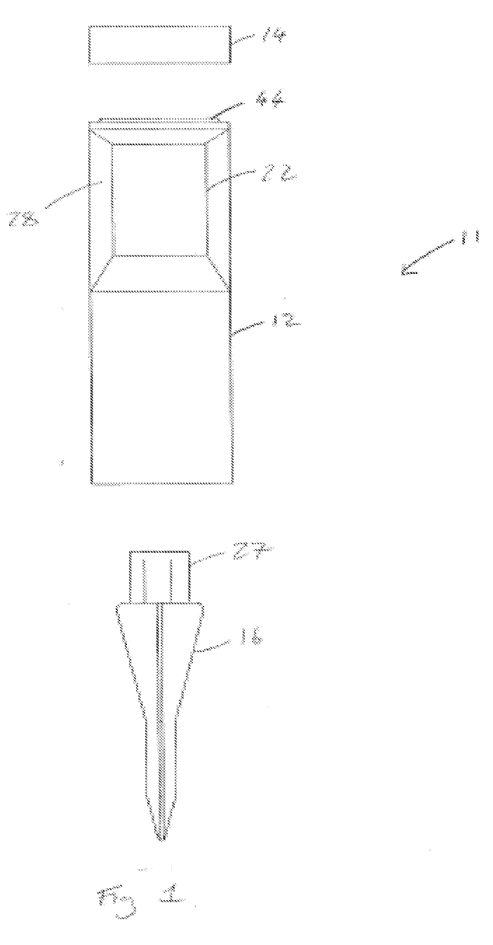

Referring to the drawings, there is shown a modular light device 10 having outwardly facing components 11 shown more particularly in FIG. 1.

The outwardly facing components 11 include a housing portion comprising a body portion 12 and a lid portion 14 engageable with the body portion 12, and a support structure, in this example in the form of a spike 16 attachable to a lower end of the body portion 12.

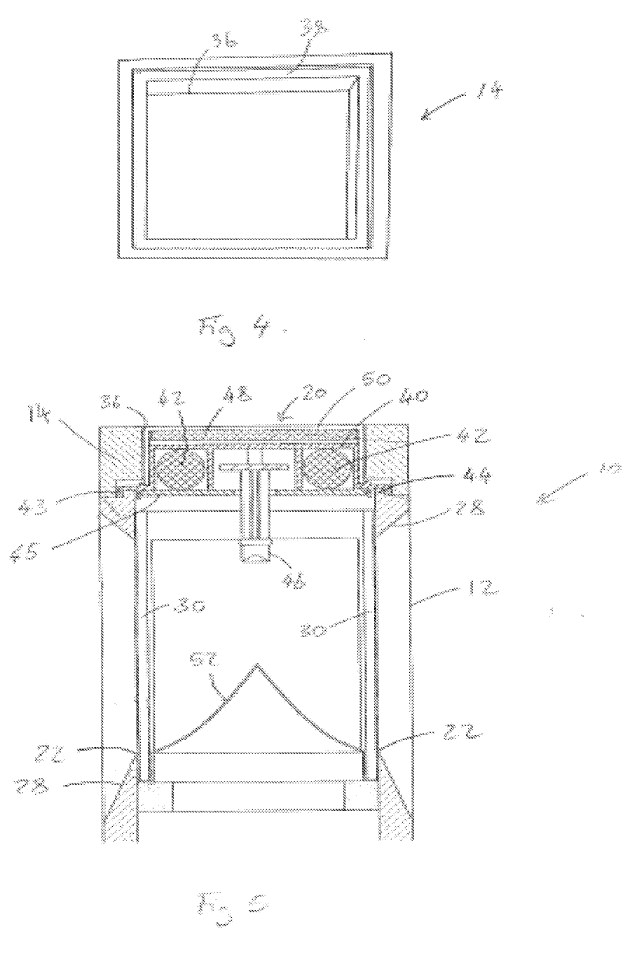

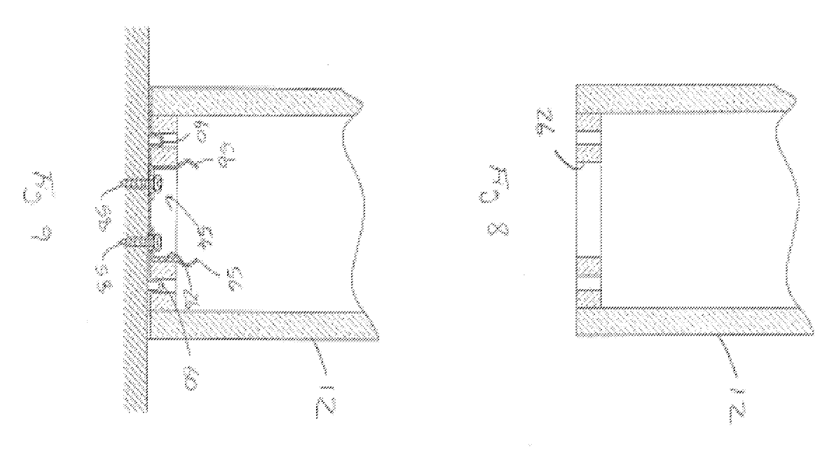

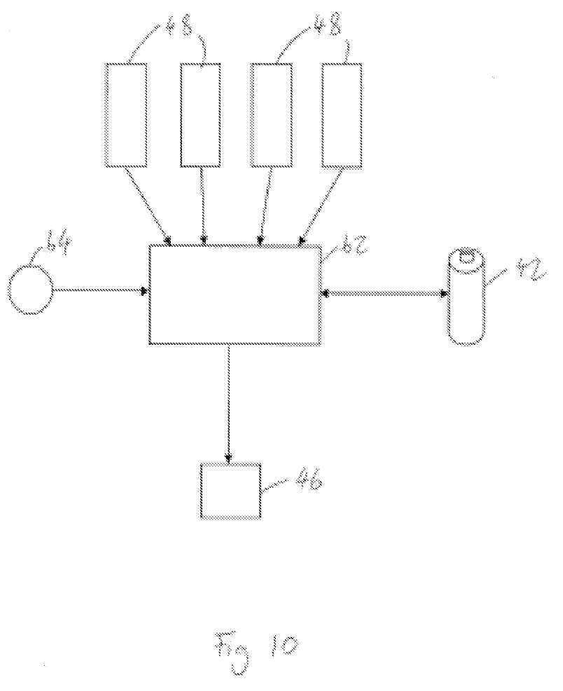

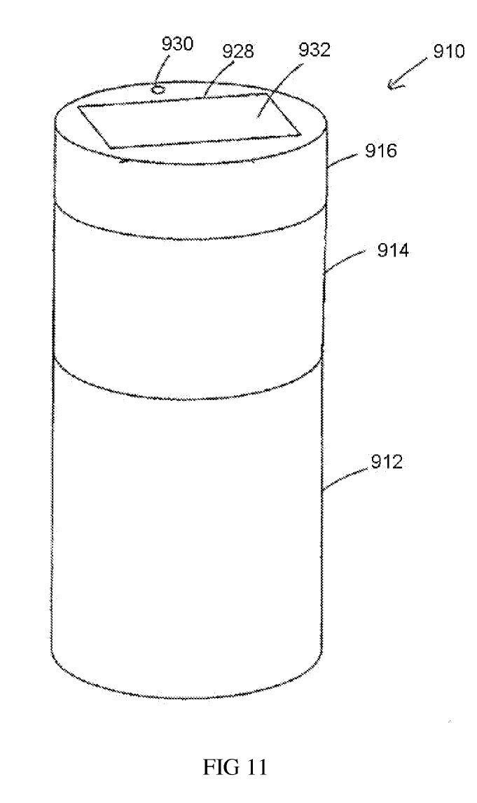

In this example, the body portion 12 and the lid portion 14 are formed of material which is prone to corrosion when exposed to the elements, such as wood, and, for this reason, the body portion 12 and the lid portion 14 are readily completely separable from all other components of the light device 10 so as to enable restorative and/or maintenance work to be carried out on the body portion 12 and the lid portion 14 without difficulty as and when necessary. In particular, the body portion 12 is arranged such that a light transmissive module 18 shown more particularly in FIG. 3, and an operative components module 20 shown more particularly in FIGS. 6 and 7 are readily disposable in and removable from the housing portion, in this example readily disposable in and removable from the body portion 12.

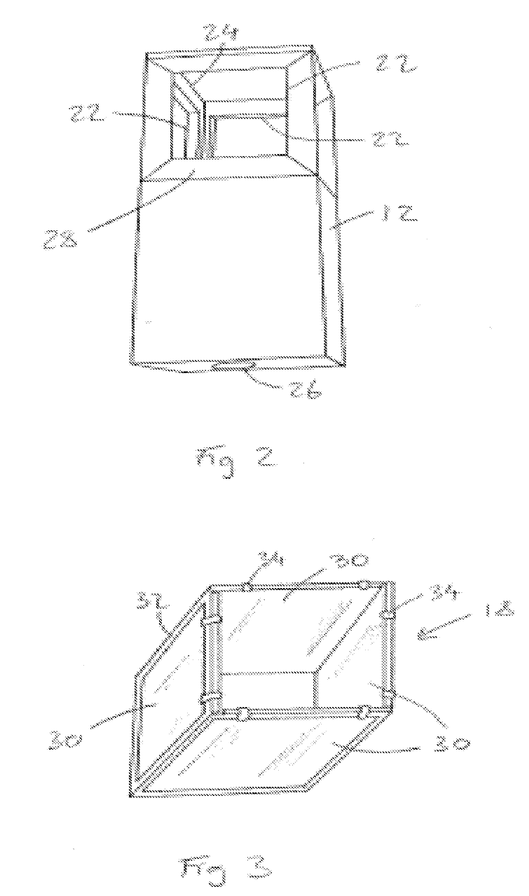

The body portion 12 includes four first apertures 22 through which light passes during use, a second aperture 24 shown more particularly in FIG. 2 through which the light transmissive module 18 and the operative components module 20 are receivable during use, and a third aperture 26 which receives a stub portion 27 of the support device 16 during use.

The body portion 12 also includes a plurality of beveled portions 28, each beveled portion 28 surrounding a first aperture 22.

Referring to FIG. 3, the light transmissive module 18 is defined by four light transmissive panels 30 which may be formed of any suitable light transmissive material such as glass or plastics material. The light transmissive panels 30 may be formed so as to be transparent or translucent. The light transmissive panels 30 are held together using a frame 32 so as to define a generally cuboid shape. In this example, the frame 32 is formed of metal material, although it will be understood that other materials are envisaged. The light transmissive panels 30 are held against the frame 32 using clips 34.

However, it will be understood that various arrangements are possible and the light transmissive module 18 is not necessarily formed of discrete light transmissive panels 30 or cuboid in shape.

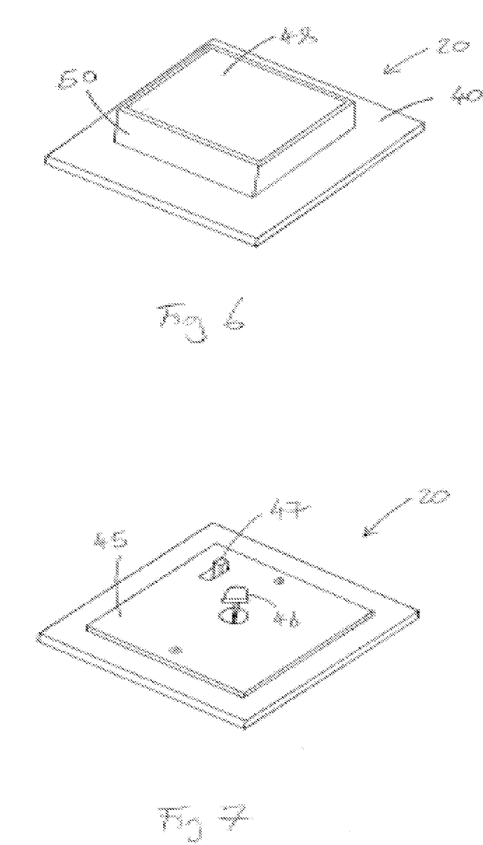

Referring to FIG. 4, the lid portion 14 includes a central aperture 36 and a stepped portion 38, the stepped portion 38 serving to ensure correct alignment of the lid portion 14 with an upstanding rib 44 provided on an upper portion of the body portion 12.

Referring to FIGS. 5, 6 and 7, the operative components module 20 includes a battery compartment 40, in this example formed of plastics material, for receiving a rechargeable power source, in this example rechargeable batteries 42. In order to ensure correct alignment of the battery compartment 40 with the body portion 12 and to minimize egress of water into the body portion 12 during use, a periphery of the battery compartment 40 is provided with a lip 43 which during use sits over the upstanding rib 44 provided on the body portion 12.

In order to facilitate removal and/or replacement of the batteries 42, a removable cover 45 is releasably secured to the battery compartment 40. A switch 47 may also be provided so as to facilitate user activation and deactivation of the operative components module 20.

The operative components module 20 also includes a light source in the form of one or more light emitting elements, in this example one or more LEDs 46 extending outwardly of the removable cover 45 to an extent such that the LED(s) 46 locate behind the light transmissive panels 30 when the lid portion 14 is engaged with the body portion 12.

The operative components module 20 also includes one or more solar panels 48 disposed between the battery compartment 40 and a transparent cover member 50 secured to an outwardly facing surface of the battery compartment 40. The arrangement is such that the cover member 50 and thereby the operative components module 20 sits snugly in the central aperture 36 formed in the lid portion 14 and light is able to fall on the solar panels 48.

The body portion may also include a reflector 52 disposed in the body portion 12 and configured such that light emanating from the LED(s) 46 is directed outwardly through the first apertures 22.

The modular light device 10 may further include a support clip 54 provided with prongs 56, the support clip 54 being fixable to a structure for example using screws 58, and the support clip 54 facilitating removable connection of the body portion 12 to the support clip 54 and thereby the structure by virtue of engagement of the prongs 56 in the third aperture 26. Projections 60 are also provided to ensure correct alignment of the body portion 12 with the support clip 54.

During daytime, electrical power supplied by the solar panes 48 serves to recharge the rechargeable batteries 42. During nighttime, electrical power from the batteries 42 is directed to the LED(s) 46.

In order to coordinate supply of electrical power from the solar panels 48 to the rechargeable batteries 42 and from the rechargeable batteries 42 to the LED(s) 46, a control unit 62 is provided.

The batteries 42 may be connected to the solar panels so as to always be available for recharging. In that way, as long at there is sufficient ambient light for the solar panels to function, the batteries will be recharged. The control unit 62 may be arranged to sense the ambient light level, by, for example using a light dependent resistor 64, and when the ambient light level is low, operate a switch to make a connection to the LEDs 46. In this way, when there is sufficient light, i.e. during the day, the solar panels recharge the batteries and the LEDs 46 are not turned on. Only when there is insufficient light, i.e. at night, does the control circuit 62 activate the switch and allow the LED's 46 to be turned on.

In an alternative embodiment, the control unit 62 may also be arranged to sense the ambient light level, for example using a light dependent resistor 64 and, if a determination is made that sufficient ambient light is available for recharging the batteries using the solar panels, a connection is made between the solar panels 48 and the batteries 42 and a recharge current flows from the solar panels 48 to the batteries 42. If a determination is made that insufficient ambient light is available, a connection is not made between the solar panel(s) 48 and the battery 42 and a current does not flow through the battery 42.

The light device may also be arranged to receive power from an external power supply, for example by providing the light device 10 with an appropriate step down transformer (not shown) connectable to mains AC electrical power and appropriate AC to DC conversion circuitry.

In addition, the LED(s) 46 may be caused to flicker and, for this purpose, the control unit 62 may be provided with an inverter (not shown) and the inverter controlled so as to generate an alternating current arranged to cause the LED(s) 46 to mimic the characteristic flicker of a flame. Alternatively, an irregular oscillating input may be applied to a switching transistor so as to cause irregular switching of current through the LED(s) 46. Appropriate biasing signals for the switching transistor may be generated using multiple oscillators, each of which is arranged to oscillate at a different frequency. For example, a base of the switching transistor may be connected to outputs of multiple Schmitt trigger oscillators arranged to oscillate at different frequencies, the Schmitt trigger oscillators for example being constructed using a CMOS 40106 hex inverting Schmitt trigger integrated circuit.

Referring to the drawings, there is shown a waterproof outdoor light device 910 which includes a body portion 912, a light transmissive housing portion 914, a lid portion 916 and a support structure, in this example in the form of a spike 918.

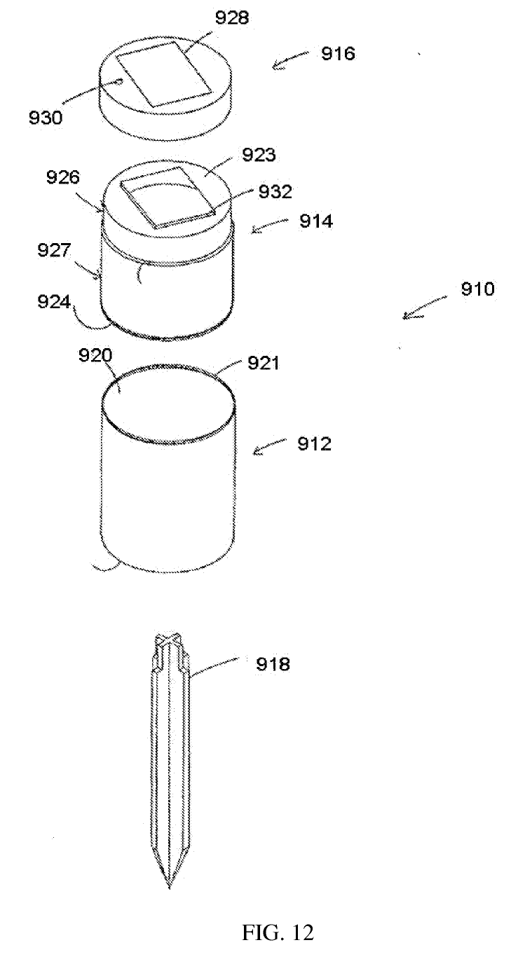

As shown more particularly in FIG. 12, the body portion 912 is of generally cylindrical configuration and has a closed lower end 919 and an open upper end 920. The upper end 920 is provided with a screw threaded portion, in this example an internally screw threaded portion 921, and the housing portion 914 is provided with a corresponding externally screw threaded portion 922, the internally and externally screw threaded portions 921, 922 facilitating screw threaded connection of the body portion 912 to the housing portion 914.

The housing portion 914 is of generally cylindrical configuration and has a closed upper end 923, an open lower end 924, and a circumferential stepped portion 925 which separates the housing portion 914 into first and second adjacent cylindrical portions 926 and 927 respectively, the first cylindrical portion 926 having a diameter which is less than the diameter of the second cylindrical portion 927.

The housing portion 914 is formed of transparent material, in this example transparent plastics material, although it will be understood that the housing portion 914 may be formed of translucent material so that light emanating from the housing portion 914 is diffused.

The lid portion 916 is of generally cylindrical configuration and has a relatively large first aperture 928 of generally rectangular configuration and a relatively small second aperture 930. The lid portion 916 is configured such that the lid portion 916 fits snugly over the first cylindrical portion 926 of the housing portion 914, the first and second apertures 928, 930 serving to allow light to pass through the lid portion 916, and thereby through the transparent housing portion 914.

The housing portion 914 also includes a raised portion 932 configured so as to be complementary in shape to the first aperture 929.

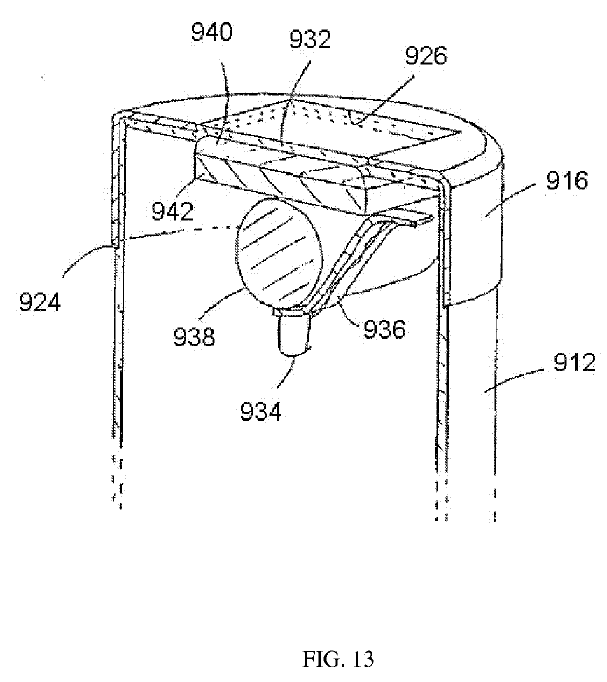

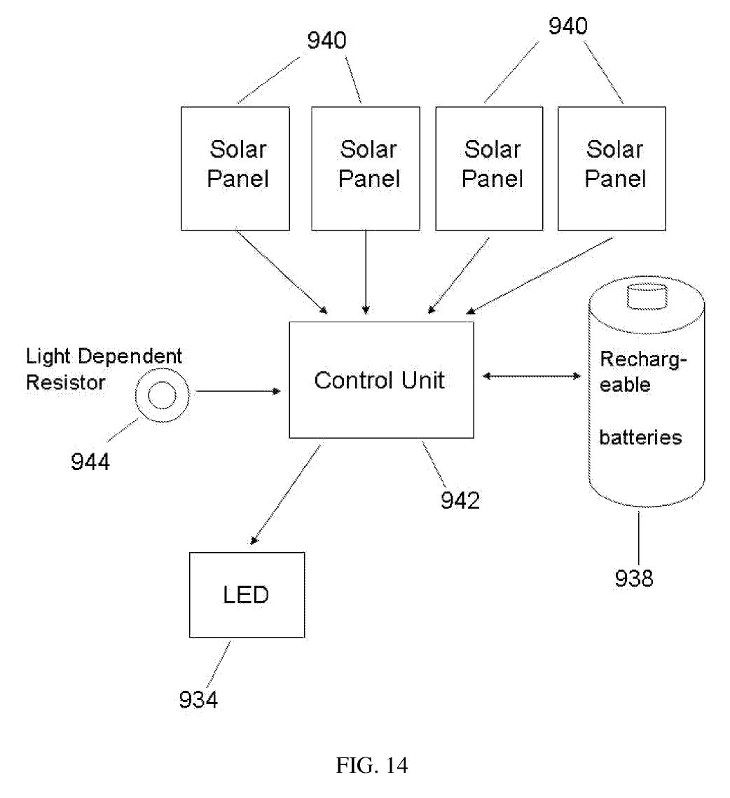

Disposed inside the housing portion 914 are operative components of the outdoor light device 910 shown more particularly in FIG. 13. The operative components include a light source, in this example in the form of one or more light emitting elements such as one or more LEDs 934. The or each LED 934 may be of any suitable type and may be arranged to emit any desired colour of light.

Mounted inside the housing portion 912 is a support member 936 which serves to hold a rechargeable power source, in this example in the form of a rechargeable battery 938. In this example, the support member 936 also serves to hold the LED(s) 934, although it will be understood that this is not essential. Also in this example, the support member 936 is formed of resilient material so as to facilitate ease of insertion and removal of the rechargeable battery 938.

Disposed upwardly of the rechargeable battery 938 are one or more solar panels 940, the solar panel(s) being disposed adjacent and immediately below the raised portion 932 of the housing portion 914. In this way, light falling on the raised portion 932 will fall directly on the solar panel(s) 940.

Operative components of the outdoor light device 910 are shown schematically in circuit diagram form in FIG. 14.

During daytime, electrical power supplied by the solar panel(s) 940 serves to recharge the rechargeable battery 938. During nighttime, electrical power from the battery 938 is directed to the LED(s) 934.

In order to coordinate supply of electrical power from the solar panel(s) 940 to the rechargeable battery 938 and from the rechargeable battery 938 to the LED(s) 934, a control unit 942 is provided. The control unit 942 may be in the form of a PCB with appropriate operative components disposed on the PCB.

The batteries 938 may be connected to the solar panels so as to always be available for recharging. In that way, as long at there is sufficient ambient light for the solar panels to function, the batteries will be recharged. The control unit 942 may be arranged to sense the ambient light level, by, for example using a light dependent resistor 9444, and when the ambient light level is low, operate a switch to make a connection to the LEDs 934. In this way, when there is sufficient light, i.e. during the day, the solar panels recharge the batteries and the LEDs 934 are not turned on. Only when there is insufficient light, i.e. at night, does the control circuit 942 activate the switch and allow the LED's 934 to be turned on.

In an alternative form, the control unit 942 may also be arranged to sense the ambient light level, for example using a light dependent resistor 944 disposed adjacent and immediately below the second aperture 930 and, if a determination is made that sufficient ambient light is available for recharging the batteries using the solar panels, a connection is made between the solar panel(s) 940 and the battery 938 and a recharge current flows from the solar panel(s) 940 to the battery 938. If a determination is made that insufficient ambient light is available, a connection is not made between the solar panel(s) 940 and the battery 938 and a current does not flow through the battery 938.

The light device may also be arranged to receive power from an external power supply, for example by providing the light device 10 with an appropriate step down transformer (not shown) connectable to mains AC electrical power and appropriate AC to DC conversion circuitry.

In addition, the LED(s) 938 may be caused to flicker and, for this purpose, the control unit 942 may be provided with an inverter (not shown) and the inverter controlled so as to generate an alternating current arranged to cause the LED(s) 934 to mimic the characteristic flicker of a flame. Alternatively, an irregular oscillating input may be applied to a switching transistor so as to cause irregular switching of current through the LED(s) 934. Appropriate biasing signals for the switching transistor may be generated using multiple oscillators, each of which is arranged to oscillate at a different frequency. For example, a base of the switching transistor may be connected to outputs of multiple Schmitt trigger oscillators arranged to oscillate at different frequencies, the Schmitt trigger oscillators for example being constructed using a CMOS 40106 hex inverting Schmitt trigger integrated circuit.

It will be appreciated that since the solar cells 940 are disposed adjacent and immediately below the raised portion 932 and the housing portion 914 is integrally formed with a closed upper portion, the risk of ingress of water through the upper portion of the housing portion 914 is avoided.

It will also be appreciated that since operative components of the outdoor light device 910 are all disposed upwardly of the open lower end 924 of the housing portion 914, the likelihood of water migrating to the operative components during use is significantly reduced.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. An improved outdoor light device comprising:
a housing portion having means to transmit light;
at least one light emitting element weather-proofingly contained within said light device;
at least one solar energy converting device arranged to convert solar energy to electrical power, weather-proofingly contained within said housing portion; and
at least one rechargeable electrical power source for supplying electrical power to the at least one light emitting element and for receiving electrical power from the at least one solar energy converting device, said at least one rechargeable electrical power source weather-proofingly contained within said light device.

2. The device of claim 1, wherein said housing portion comprises a light transmissive portion having a lower end and a closed upper end; and wherein said at least one solar energy converting device is disposed adjacent to said closed upper end of the housing portion; and further comprising: a lid portion configured so as to fit snugly over said closed upper end and having a first aperture located on the lid portion such that when the lid portion is disposed on said closed upper end, light is able to pass through said closed upper end of the housing portion and fall on the at least one solar panel.

3. The device of claim 2 wherein said lower end of the housing portion is open.

4. The device of claim 2 wherein said housing portion is arranged to receive said at least one rechargeable electrical power source.

5. The device of claim 2 wherein said lid portion is formed of opaque material selected from the group of materials consisting of plastics, metal, wood and cold cured resin material, or some combination thereof.

6. The device of claim 2 wherein said housing portion is formed of a material selected from the group consisting of transparent material, translucent material and plastics material, or some combination thereof.

7. The device of claim wherein said housing portion is connectable at the lower end to a body portion formed of an opaque material; and wherein said lower end of said housing portion comprises a first screw threaded portion and wherein an upper end of said body portion comprises a second complimentary screw threaded portion such that said first and second screw threaded portions facilitate screw threaded connection of said housing portion to said body portion.

8. The device of claim 7 where said housing portion further comprises a circumferential stepped portion separating said housing portion into a first and a second cylindrical portions, said first cylinder portion being disposed at the upper end of the housing portion and being of reduced diameter relative to said second cylindrical portion.

9. The device of claim 2 wherein said upper end of the housing portion further comprises a raised portion configured to fit snugly in said first aperture.

10. The device of claim 1 further comprising a support member arranged to hold said at least one rechargeable power source.

11. The device of claim 10 wherein said support member is made of a resilient material and wherein said support member further comprises means to hold said at least one light emitting element.

12. The device of claim 1 further comprising means for causing said at least one light emitting element to emit flickering light.

13. The device of claim 1 wherein said light emitting element is an LED arranged to emit light of any color.

14. The device of claim 2 wherein said at least one light emitting element, said at least one solar energy converting device and said rechargeable electrical power source are all disposed in said housing portion adjacent the upper end

15. The device of claim 1 wherein said housing portion comprises a body portion having at least one first body portion aperture; and further comprising a removable, operative components module; said operative components module comprising said at least one light emitting element and said at least one solar power converting device, and said operative components module being arranged to receive said at least one rechargeable electrical power source; and said operative components module being receivable in and separable from the housing portion.

16. The device of claim 15 further comprising a light transmissive module, said light transmissive module being receivable in said body portion and configured such that when the light transmissive module is received in the body portion, portions of the light transmissive module are disposed over said at least one first body portion aperture.

17. The device of claim 15 where said body portion further comprises an open upper end portion; and further comprising a lid portion having a lid portion aperture, the lid portion being engageable with the upper end portion of the body portion and the lid portion being configured such that when the lid portion is engaged with the body portion, the at least one solar power converting device is disposed adjacent the lid portion aperture.

18. The device of claim 17 wherein said operative components module is receivable in the body portion.

19. The device of claim 17 wherein said operative components module is receivable in said lid portion.

20. The device of claim 17 wherein said operative components module is receivable in said lid portion and said body portion.

21. The device of claim 16 wherein said light transmissive module is at least partially formed of material that is a transparent material or a translucent material, or a combination thereof.

22. The device of claim 16 wherein said light transmissive module is formed of a plurality of connected light transmissive panels.

23. The device of claim 22 wherein said light transmissive panels are be connected together using a frame which may be formed of metal material.

24. The device of claim 23 wherein said light transmissive panels are removably connected to said frame using clips.

25. The device of claim 16 wherein said light transmissive panels are formed of a material that is glass or plastics material, or some combination thereof.

26. The device of claim 15 wherein said operative components module further comprises a battery compartment for removably receiving said at least one rechargeable electrical power source, and a transparent cover member engageable with said battery compartment, and wherein said battery compartment and said transparent cover member are configured so that said at least one solar power converting device is receivable between said battery compartment and said transparent cover member.

27. The device of claim 26 wherein said transparent cover member is a complimentary shape to the shape of said lid portion aperture so that the transparent cover member and thereby said operative components module is able to sit snugly in said lid portion aperture.

28. The device of claim 15 wherein said body portion is provided with at least one bevelled portion, said beveled portion defining a first body portion aperture.

29. The device of claim 15 wherein said body portion further comprises a second body portion aperture formed in a lower end portion of said body portion, said second body portion aperture serving to receive a support member during use.

30. The device of claim 29 wherein said support member is a spike.

31. The device of claim 29 further comprising a support clip fixable to a structure, said support clip being engageable with said second body portion aperture so as to facilitate removable connection of said body portion to said support clip.

32. The device of claim 29 wherein said support clip is fixed to said structure by one or more screws.

33. The device of claim 29 wherein said support clip comprises a plurality of prongs.

34. The device of claim 15 wherein said body portion is formed of wood.

35. The device of claim 15 wherein said lip portion is formed of wood.
